(19) United States
(12) Patent Application Publication
(10) Pub. No.: US 2016/0088474 A1
(43) Pub. Date: Mar. 24, 2016

(54) Performing Pairing And Authentication Using Motion Information

(71) Applicants: Ned M. Smith, Beaverton, OR (US); David A. Sandage, Forest Grove, OR (US); William C. Deleeuw, Beaverton, OR (US); Nathan Heldt-Sheller, Portland, OR (US); Nathaniel J. Goss, Portland, OR (US); John C. Neumann, Portland, OR (US)

(72) Inventors: Ned M. Smith, Beaverton, OR (US); David A. Sandage, Forest Grove, OR (US); William C. Deleeuw, Beaverton, OR (US); Nathan Heldt-Sheller, Portland, OR (US); Nathaniel J. Goss, Portland, OR (US); John C. Neumann, Portland, OR (US)

(21) Appl. No.: 14/493,613

(22) Filed: Sep. 23, 2014

(51) Int. Cl. H04W 12/06; H04W 74/00

(52) U.S. Cl. CPC H04W 12/06; H04W 74/002; H04W 84/18

(57) ABSTRACT

In one embodiment, a security logic of first portable device is configured to receive first motion sample information from at least one motion sensor of the first portable device and second motion sample information from at least one motion sensor of a second portable device, the first and second motion sample information obtained responsive to training movement of the first and second portable devices by a first user. Based on the motion sample information, the security logic is configured to generate a device pairing value, generate a first confidence value based on the first motion sample information and first reference motion sample information stored in the first portable device corresponding to reference movement of the first portable device by the first user, generate a relationship key pair for a relationship, and communicate the first confidence value and a public key of the relationship key pair to the second portable device using the device pairing value. Other embodiments are described and claimed.

### TECHNICAL FIELD

Embodiments relate to pairing and authentication operations on computing devices using motion information obtained from one or more users.

### BACKGROUND

Ad-hoc networks are typically formed when computing devices such as mobile devices seek to interact. In some scenarios, information regarding the ad-hoc interactions may be remembered in anticipation of subsequent ad-hoc interactions, possibly in a different location but involving the same devices discovered during the first ad-hoc interaction.

Secure ad-hoc interactions may require device pairing and user authentication to be accomplished using ad-hoc means. Traditional methods for device pairing and user authentication often involve a trusted third party that pre-registered and enrolled devices and users. However, such trusted third party approaches do not scale in ad-hoc environments.

### BRIEF DESCRIPTION OF THE DRAWINGS

FIG. 1 is a block diagram of a system environment in accordance with an embodiment.

FIG. 2 is a flow diagram of a method for establishing a digital relationship using motion-based user authentication and motion-based device pairing in accordance with an embodiment.

FIG. 3 is a timing diagram of the various phases of a motion pairing and authentication protocol in accordance with an embodiment of the present invention.

FIG. 4 is a block diagram of a portion of a system in accordance with an embodiment of the present invention.

FIG. 5 is a block diagram of a system arrangement in accordance with an embodiment of the present invention.

FIG. 6 is a block diagram of another example system with which embodiments can be used.

### DETAILED DESCRIPTION

In various embodiments, one or more sensors of multiple computing devices, e.g., motion sensors, may be used to establish highly entropic device pairing and user authentication reference templates. Embodiments may combine the process of device pairing with user authentication training Such operations may be particularly applicable to the so-called step zero problem in cryptographic systems. Data obtained from sensors provide context for authentication during training (by one or multiple users) to a plurality of classifiers, including a first classifier to generate shared entropic values (which may be used to pair devices) and one or more other classifiers to generate biometric templates (which may be used for user authentication).

Still further, even greater security and trust properties may be provided by way of a trusted execution environment (TEE) established in the devices. Understand also that the pairing and authentication protocols described herein may be performed without the presence of a trusted third party such as a certificate authority in accordance with a public key infrastructure (PKI). This is so, as context information associated with pairing and authentication processes assume the role of the third party authority.

The keys generated herein, referred to as relationship pairing keys (RPKs), have cryptographic properties and may be used in various embodiments without the need for interaction with a trusted third party (such as a certificate authority (CA) to confirm context surrounding association/binding of key to person. Instead, embodiments provide context directly by way of biometric-based motion context to authenticate a user. This authentication context can be associated with the RPK keys by the TEE. The TEE binding of RPKs to context values effectively performs the operations of a PKI Registration Authority (RA) and Certificate Authority (CA), and thus without use of the infrastructure of conventional PKI methods.

Ad-hoc network interactions are often prefaced by in-person interactions. Such interactions can support secure communications thereafter if a key exchange operation is performed at the point of the interaction. In various embodiments, exchanged keys may capture in-person context sufficiently to enable users to recognize the trust semantics that exist surrounding the keys. In an embodiment, these trust semantics may include an ability to authenticate both the person and the device that performed the in-person interaction.

Although the scope of the present invention is not limited in this regard, embodiments may leverage a variety of sensors and other components that are commonly available in mobile devices. In one example, motion sensors (e.g., 6-axis or 9-axis sensors) may be used to obtain biometric input such as user movement and gesture recognition. To this end during an in-person interaction between two users each having a mobile device that the users desire to pair for purposes of device-to-device communication (e.g., while the devices are located locally with each other or remotely), both users in turn hold both devices and perform one or more (e.g., a series) of typical (for the user), prescribed or random movements to provide training data to both devices simultaneously.

Training initially involves capturing sensor readings and associating the captured sensor information with a corresponding device identifier for the device and a user identifier for the user. If the users have previously been authenticated to the device, then the current user's authentication state may also be associated with the capture. In an embodiment, both users perform training by performing the motion training using both devices. Multiple classifiers, which are configured to extract information useful for secure reconstruction of the in-person interaction while the key exchange is performed, then process the collected samples. Note that this sample data produces a pseudo-random number, which can then be used to perform symmetric encryption or for authentication purposes.

Key exchange may involve use of a symmetric key exchange protocol (e.g., Diffie-Hellman) to construct a secure channel over which additional keys (such as Rivest Shamir Adleman (RSA) public/private key pairs) may be exchanged, along with at least certain attribute information derived by the separate classifiers.

In turn, both devices can authenticate the in-person interaction context by comparing the resultant values, e.g., using compare functions that satisfy an acceptable error rate. A function that produces a shared entropic value may be used to align the first and second entropic values, and discard bits that do not match according to a bi-conditional logic (e.g., if !XOR(a, b)=1, else 0), where a and b are a given user's samples obtained from the 2 different devices). Note that the compare function may reduce the axes of the sample data (e.g., from x, y, z to magnitude) and use a time-based correlation function to mutually align to the most likely starting point in each signal. In one embodiment, this NOT XOR operation is a way to combine two sets of motion data into one.

The motion sensors on both devices are thus used to create a device pairing identifier (device ID) for a given user (and associated with that user's device) based on that user's biomechanics. The NOT XOR operation may be performed on received motion sensor data in a bitwise fashion to smooth the data. If a given bit in the bitstream agrees between the motion sample data from both devices, then a TRUE (logic 1) is output, otherwise a FALSE (logic 0) is output. If the ratio of TRUE to FALSE bits approaches 1, then the device ID is acceptable. If it approaches 0, then it is unacceptable. A threshold policy can be used to determine where to draw the line. In different embodiments, a device ID value may be generated using either A or B actual sensor input, or the actual sensor input data can be combined using a secure hash algorithm to produce a value that is an amalgamation of both. Embodiments thus may use a NOT XOR operation (or similar operation) as a smoothing function with a threshold mechanism controllable by policy to enable a user to specify how accurate/lenient motion-based authentication is to be.

In turn, a biometric authentication function may be used to produce a reference template from the collected training data, where the sample collected from a first user produces a reference biometric template suitable for authenticating the first user within a certain confidence rate. The sample collected from a second user produces a reference biometric template suitable for authenticating the second user within a certain confidence rate. Note also in an embodiment, axis reduction may be applied to eliminate specific orientation of one or both devices. Further, in an embodiment, a correlation function may be applied to align the most likely starting point of two asserted signals. In an embodiment, the reference template and acceptable confidence threshold value are used to compare a contemporary sample that satisfies the confidence threshold as part of an authentication challenge.

In some embodiments, date and time and/or other context information (such as location of the in-person interaction) may be used in computation of a device ID to increase entropy and to further disambiguate the pairing event. If a pairing event stipulates for proof that a human performed the pairing to avoid accidental pairing (for example when devices are in the glove compartment of the same car), the users can be caused to perform a specific action to demonstrate mutual intention. For example, the pairing operation may require both users to simultaneously perform a given swipe pattern on a touch screen of their mobile devices. In such cases, these swipe results are shared with the opposite device and included in the device ID computation. In some embodiments, accidental pairing may be prevented by such simultaneous touch operation.

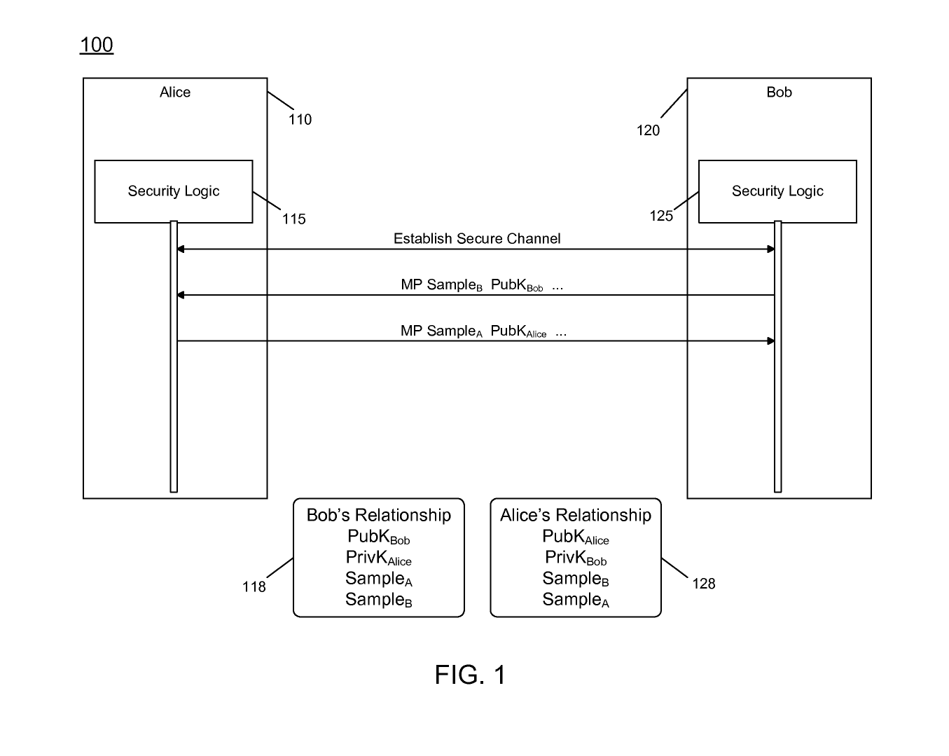

Referring now to FIG. 1, shown is a block diagram of a system environment in accordance with an embodiment. As shown in FIG. 1, an environment 100 is a local environment that exists when the users of different portable devices, namely a first portable device 110 and a second portable device 120 have an in-person interaction such that, for purposes of a secure pairing as described herein, each of the users can access the other user's portable device. In general, the portable devices may be any type of portable computing device, such as smartphone, tablet computer, e-reader, wearable or so forth.

As shown, first portable device 110 includes a security logic 115, which in various embodiments may be implemented as a standalone processor or security logic within a general-purpose processor such as a system on a chip (SoC) of the device. Of course many other implementations of security logic to perform a motion-based pairing as described herein are possible in other embodiments. As further illustrated, first portable device 110 further includes a storage 118, which may be configured as a volatile or non-volatile storage of the device. In various embodiments, storage 118 may include a relationship database including a relationship entry for the pairing between device 110 other devices. Illustrated in FIG. 1 is an entry for a relationship between the users of portable devices 110 and 120 (“Alice” and “Bob,” respectively). As similarly shown, second device 120 includes a security logic 125 and a storage 128 having a similar stored entry.

As will be described further herein, a motion-based pairing protocol may be performed between the devices to enable receipt of training data regarding each of the user's independent training of both devices. Based on this training information obtained during a training phase, a relationship pairing key may be generated, along with a confidence value regarding a relative match between the user/owner of the local device's motion sample during training and a reference motion template previously stored by the user/owner.

When the first and second users (“Alice” and “Bob”) meet in person, motion and/or other sensors on both devices collect sample data that can be used to both pair the devices (for generation of device keys) and pair the users using a digital relationship context for exchanging relationship keys. Note that this initial key exchange may have some amount of variance or noise (after sample data reduction and correlation), given that in many embodiments this initial key may only be used for purposes of performing an initial pairing and deriving asymmetric keys. However the strength of this initial key exchange is sufficient to prevent replay and socialization attacks. Note that such negotiated asymmetric key pair may be later used to authenticate the users and create a secure channel between devices.

After both users perform a brief training exercise in which both devices receive training data from both users, the devices may subsequently authenticate the users when they are no longer physically present in the same location. In an embodiment, the sample data may be compared to a motion factor reference template (e.g., previously generated based on earlier user input) to compute an error value corresponding to the differential between the high quality reference template and the trained sample. An expected or threshold error value may be shared during relationship pairing. Note that suggested error thresholds may be automatically produced based on the error measured during situations when both devices are known to be moved together.

In the high-level view of the protocol shown in FIG. 1, various information is shared between the devices. In an embodiment, a secure session and secure path may first be established between the devices prior to communication of such information. As seen, first portable device 110 may provide a local motion sample for the user of the first device, Alice, and a public key portion of a relationship pairing key pair generated in the training phase. Similarly, second portable device 120 may provide a local motion sample for the user of the second device, Bob, and a public key portion of a relationship pairing key pair generated in the training phase. Thus as shown at the completion of training, the corresponding entries in storages 118, 128 include a public key of a relationship pairing key for the other device and a private key of the relationship pairing key for the local device, and corresponding motion samples for the local and remote devices. Note that the entries within the respective databases thus include relationship information (each associated with a different user/device combination) and provide a measure of trust by a first user of a second user. Understand that while shown these limited communications and information storage, additional communications may be part of the protocol, along with additional information to be stored in the corresponding storages and/or other locations.

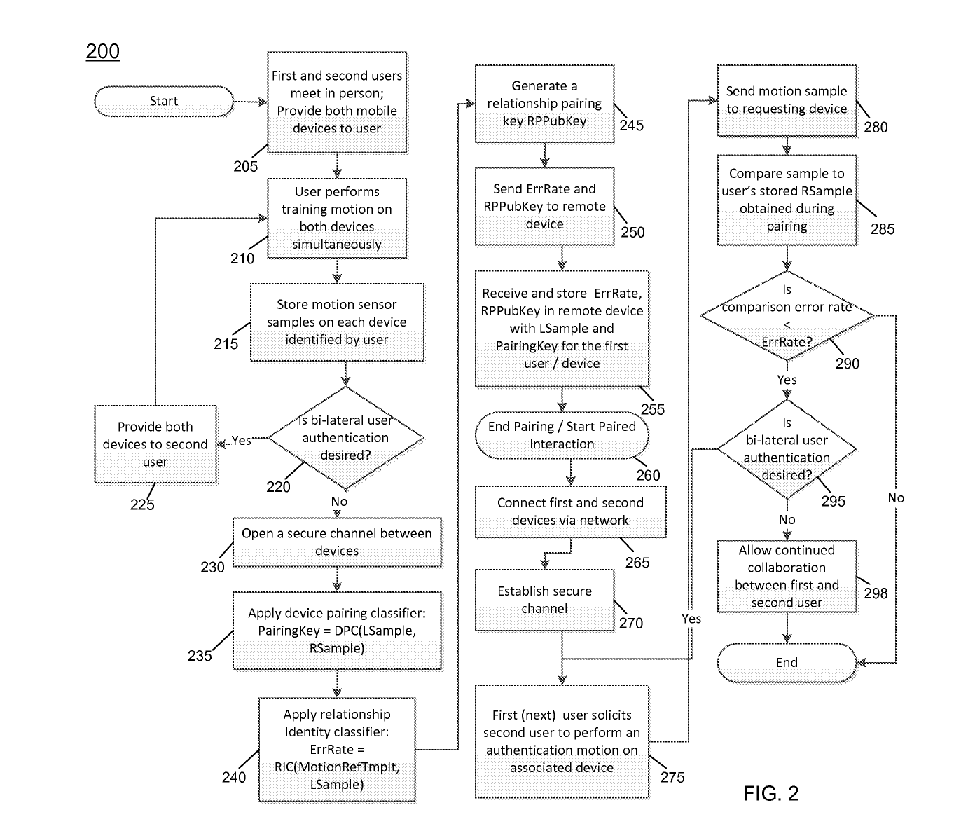

Referring now to FIG. 2, shown is a flow diagram of a method for establishing a digital relationship using motion-based user authentication and motion-based device pairing in accordance with an embodiment. While the operations to be described with regard to FIG. 2 are generally with focus on a first computing device that is owned by a first user, understand that similar operations can be performed on a corresponding second computing device owned by a second user. And with regard to the training phase, understand that both users will access and perform a motion-based training with both devices to enable the digital relationship to be established. Thereafter for any given motion-based pairing between the two devices, understand that the users need not be co-located and the users and devices may be remotely located and connected via a given wide area network such as a cellular network, the Internet or so forth.

As seen, method 200 begins during an interaction between users at block 205 where a first user is provided with the mobile device of the other user such that this first user has possession of both mobile devices, e.g., handheld one on top of another in the first user's hand. Note that during the operations, an application such as a sharing application may be active on both devices, which may direct the various user training operations and the corresponding pairing operations to be performed by the hardware of the devices. The motion-based training begins at block 210 where the user performs a motion that is thus common to both portable devices. As examples, the user may hold, carry and/or shake the devices simultaneously. The users may assume orientation of axis between the two devices does not matter for training purposes. This may be so, as embodiments may perform axis translation functions that normalize sensor data (e.g., motion reading accelerometer, gyrometer and magnetometer) along each axis to account for common orientation combinations including front-front, front-back, back-back, top-top, top-bottom. Additionally, spectral analysis may include magnitude and phase information analysis for similarity over multiple axes.

Responsive to such motion, at block 215 motion samples are stored on each of the devices and are associated with the given user. Many different types of motion sensors may be leveraged independently or collectively and may include any types of accelerometers, position sensing devices such as a global positioning system (GPS) sensor and so forth. In some embodiments, motion on multiple axes may be combined to form a magnitude function, eliminating the need to precisely align devices. Next control passes to diamond 220 to determine whether a bilateral user authentication is desired. If so, the first user provides both devices to the second user (block 225). As such, steps 210 and 215 may be iteratively performed by both users with both devices.

Still with reference to FIG. 2, after receipt of the motion information during this training phase, control passes to block 230 where a secure channel may be opened between the devices. Although the scope of the present invention is not limited in this regard in an embodiment an Intel® Sigma session may be set up between the devices. Next control passes to block 235 where pairing keys may be generated on both devices (having the same values for the corresponding user). In an embodiment a device pairing classifier may be executed to generate such pairing key using the locally received motion sample for the corresponding user and the remotely received motion sample for the same user.

Still referring to FIG. 2, control next passes to block 240 where an authentication value may be generated. More specifically, this authentication value may be based on the local sample for the local user and a reference template. In an embodiment, a relationship identity classifier may be executed to obtain this authentication value. The template may be a motion reference template previously obtained from the user. Note that for privacy reasons, the user(s) may not want to share a high resolution biometric reference template with a counterpart. In such cases, this high resolution reference template can be used to compute a confidence value (error variance) that is expected for the given digital relationship. It is then this confidence value that is provided to the other device, instead of the high resolution template, and which may be a reduced template (e.g., in amount of context or other information), yet sufficient to provide an acceptable error rate when used in a device for purposes of comparison with a received motion sample during an authentication phase. In this way, high quality reference template information can be maintained privately as privacy sensitive information, and not be shared with other users (even trusted third parties such as a certificate authority).

Control next passes to block 245 where a relationship pairing key may be generated, e.g., as an asymmetric key pair. More specifically, this relationship pairing key may include a public key and a private key and may be generated based on independent random number systems. In other embodiments, the asymmetric keys can be derived based on a shared symmetric key. In one embodiment, this relationship pairing key may be generated as a RSA key pair or an elliptical curve key pair. Control next passes to block 250 where the authentication value and the relationship public key may be sent to the remote device, e.g., using the pairing key. In turn at block 255 the remote device receives these values and stores them in a corresponding entry of a relationship database for the relationship between the two computing devices and their users. Note further that additional information stored in this entry includes a local motion sample received in the second device responsive to the first user's interaction with that device during training phase and a corresponding relationship pairing key for that device (as determined in the second computing device during its training).

Then control passes to block 260 where the pairing process between the two devices is thus completed. Note of course that the same operations described above primarily with regard to the first device equally occur on the second computing device (and for the second user) so that the pairing may be established.

Still referring to FIG. 2 after establishment of pairing, a paired interaction may begin by performing an authentication process between the two devices according to a motion-based authentication. To begin such authentication, the devices may first connect by a given network (block 265). For example, such network may be a given wireless or cellular network. After a connection, a secure channel is established (block 270). Various techniques may be used to establish the secure channel. As one example, asymmetric relationship pairing keys previously exchanged (at block 245) may be used. In another case, a symmetric relationship pairing key such as a device ID may be used to authenticate an Intel® Sigma session key exchange (in block 230) that results in pre-shared keys, which in turn may be supplied to a transport layer security (TLS) pre-shared key (TLS-PSK) protocol.

Control next passes to block 275 where the first user seeks second user input to perform an authentication motion. Note that this authentication motion may generally be similar to that which the second user performed during training so that the authentication may proceed correctly. This is the case, as users typically perform various motions with a high degree of similarity of movements such that a motion-based authentication can be performed in a highly secure manner.

After input of this motion information into the second device, the second device sends this motion sample to the first device (block 280). Next, control passes to block 285 where the first device compares this received motion sample to a stored remote motion sample. Control next passes to diamond 290 to determine whether there is a match to at least a threshold level. This comparison may include reducing axes (reduce x,y,z accelerations to a single acceleration magnitude signal) and correlating in time to identify the best possible mutual starting alignment point. In an embodiment, this determination may be made by a comparison between the two motion samples to determine whether the error rate between them is less than a threshold amount, which in an embodiment may correspond to the authentication value previously sent. If so, control passes next to diamond 295 to determine whether a bilateral user authentication is desired. If so, control passes back to block 275 discussed above. Otherwise or after the second such authentication, control passes to block 298 where continued collaboration may occur between devices. Note that prior to such continued collaboration, various communications may be encrypted, e.g., according to keys derived e.g., from the relationship pairing key structure. Further the scope of such communications or sharing may be controlled according to sharing policies of different users/devices. Understand while shown at this high level in the embodiment of FIG. 2, the scope of the present invention is not limited in regard.

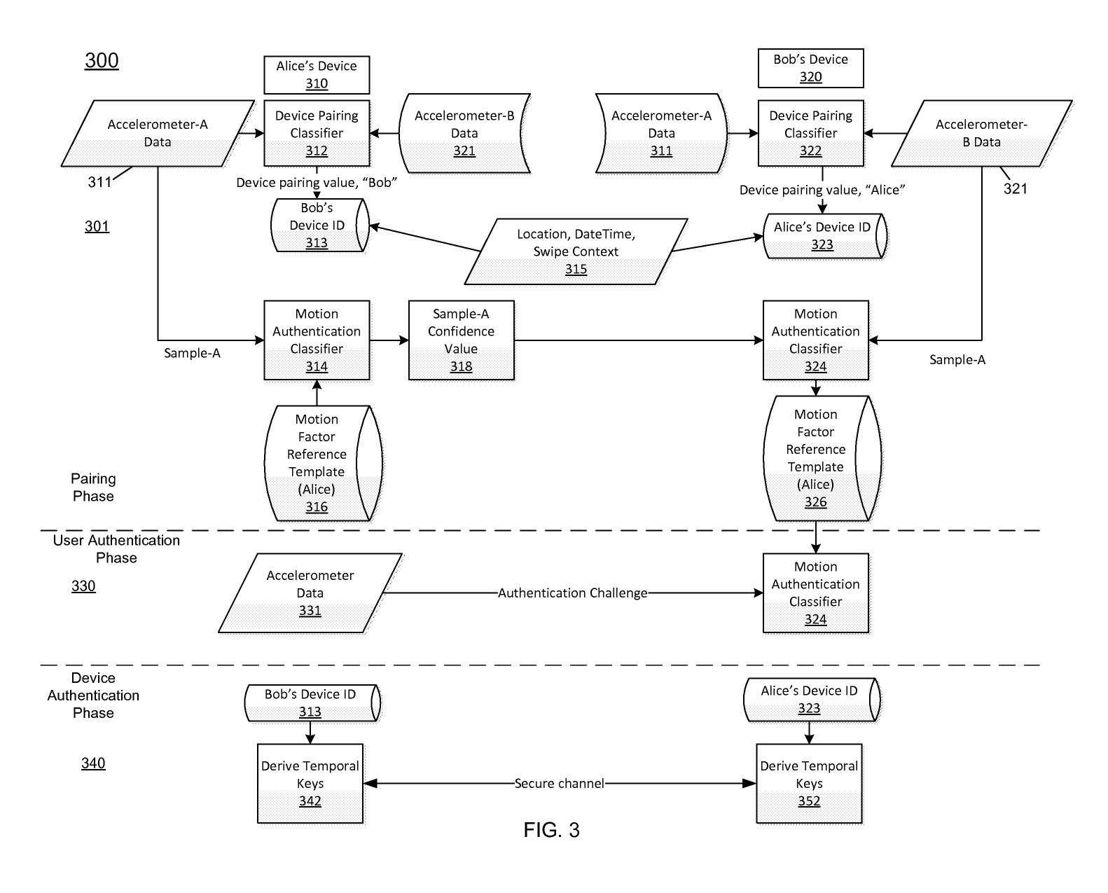

Referring now to FIG. 3, shown is a timing diagram of the various phases of a motion pairing and authentication protocol in accordance with an embodiment of the present invention. More specifically FIG. 3 shows operations performed in a device pairing phase and a user authentication phase, followed by a device authentication phase. While all these phases may be performed at a single time, e.g., when users initially interact, understand that in many cases the pairing phase may be performed at an original time, with user and device authentication occurring at a later date, when one or more of the users seeks to make a connection with the other user's device.

FIG. 3 thus shows motion-based pairing of devices using both device and authentication classifiers (for one user) to obtain a device pairing value and device ID that can be used, along with later user input for user authentication and device authentication phases.

Thus as shown in FIG. 3, in an environment 300 multiple phases occur, including a pairing phase 301, an authentication phase 330, and a device authentication phase 340. In this environment, two user devices, namely a first user device 310 owned by a first user, Alice, and a second user device 320 owned by a second user, Bob, are present. To enable motion-based pairing and authentication as described herein, an initial pairing phase 301 occurs in which both users are trained to their own devices and each other's devices, as discussed above. To this end, with reference to first device 310, motion sensing information, namely accelerometer data, is received both from the local device (block 311) and from second device (block 321). Assume for purposes of discussion that Alice is being trained and authenticated as described herein, and thus this motion data from both devices is with regard to Alice's training movements. Similar operations occur on second user device 320.

As seen, the motion sample information from both devices is provided to a device pairing classifier 312, which generates a device pairing value for the relationship between Alice and Bob (referred to as “Bob”). In an embodiment, both devices generate a common device pairing value for the relationship between the devices and users, and from this information and possibly additional information, including context information 315 (that in an embodiment includes location, date and time information, among other possibly sample context information) a device identifier is generated. Specifically, first device 310 generates a device identifier 313 associated with the second device, and vice versa (with second device 320 generating device identifier 323).

In device pairing phase 301, device pairing classifiers 312 and 322 may execute to generate a device pairing value based on user sample data (obtained from both devices) using the algorithm: if !XOR(a,b)=1→T; else →F, in an embodiment, and may further include axis reduction functions and time correlation to optimally match starting points. Note that if the length of the device pairing value is less than a threshold value (e.g., less than 256 bits), then the sensors did not produce enough similar values to justify device pairing, and thus pairing is terminated. In another embodiment, the device pairing classifiers may perform the XOR operation then select the local sample in the case of the local user or select the remote sample in the case of the remote user, where the ratio of logic ones to zeros resulting from the XOR operation exceeds a confidence threshold, e.g., a ratio greater than 90%.

In an embodiment, device IDs can be generated using a secure hash computation according to:

DevIDA=SHA256(motion value, “Alice”) and

DevIDB=SHA256(motion value, “Bob”).

In turn, these device IDs can be used to generate temporal keys that are used for data sharing between devices during a device authentication phase. Note in some embodiments, the Device ID computation may include context information 315 (e.g., location context) that fixes the pairing event to a specific place and time for further uniqueness of the pairing event. For example in such embodiments the device IDs may be computed as follows: (e.g., DevIDA=SHA256 (motion value, “Alice”, locationA, date-timeA, locationB, date-timeB)).

In still other embodiments, device ID computation may include assertion of user presence context based on a predetermined user input operation, such as the 2 users performing a set of simultaneous swipe operations on their respective devices. As one example, such simultaneous swipe may be achieved by computing the device ID in stages where the initial stage iteratively feeds an intermediate DeviceID into the computation. For example:

DevID_{INITIAL}=DevID_{A};

DevID₁=SHA256(DevID_{INITIAL}, swipe_motion_{—}1);

DevID₂=SHA256(DevID_{INITIAL}, swipe_motion_{—}2);

DevID₃=SHA256(DevID_{INITIAL}, swipe_motion_{—}3).

This iterative process may continue until all swipe motions are completed. If both parties perform the same swipe motions correctly, then the device ID values will be equivalent. In this situation, subsequent device ID-based authentication protocols will fail if the device IDs differ.

As further shown as part of the pairing phase 301, the local sample information at block 311 is further provided to a motion authentication classifier 314, which further receives a motion factor reference template 316, which may be previously obtained motion sample from Alice. Based on these 2 inputs, classifier 314 generates a confidence value 318, which it provides to a motion authentication classifier 324 of second device 320, which in turn generates a motion factor reference template 326 to be used for authentication purposes. Note that in the embodiment shown motion factor reference template 326 is not the same as high quality motion factor reference template 316 of first device 310 and instead acts as an authentication confidence value, e.g., the error rate described above regard to FIG. 2, so that the high quality secure information of first computing device 310 need not be shared directly with second computing device 320 (in an embodiment). Thus at this point the pairing protocol is completed with regard to Alice. Note that similar operations may be performed to thus pair Bob with the devices.

Thereafter, an authentication phase 320 may occur. As part of this authentication phase, Alice may generate a new motion sample and provide accelerometer data 331 to motion authentication classifier 324 of second device 320. In an embodiment, an appropriate authentication challenge protocol may occur prior to sending this motion data. During user authentication phase 330, each device may receive a user motion template from the other device. Thus as shown in FIG. 3, Alice's motion sensor collects a motion template 321 that is supplied (remotely) to authentication motion classifier 324. Bob's previously computed reference template 326 for Alice (including confidence value) verifies Alice's challenge. The confidence value helps the device according to a user authentication policy to determine if a given variance is expected, given the original meeting of Alice and Bob. When this motion information is authenticated using the previously stored motion factor reference template 326, a device authentication phase 340 may then occur.

As shown in FIG. 3, device authentication phase 340 may be performed after a secure channel is established between the devices, e.g., in accordance with a TLS-PSK protocol. Using corresponding device identifiers 312, 323, a set of temporal keys may be derived, namely temporal keys 342, 352, which may be used to perform secure communication between the devices as described herein. Understand while shown at this high level in the embodiment of FIG. 3, many variations and alternatives are possible.

Thus in various embodiments one or more platform sensors (e.g., at least a motion sensor) may provide input to multiple classifiers for device pairing and user pairing. In some cases security may be enhanced, as these pairing operations may be performed in a TEE. As described above, 2 different devices (each including one or more accelerometers) may be held together during a physical world meeting to obtain simple data that can be used to both derive device IDs and perform simple biometric training during the same physical world meeting.

The pairing and key exchange algorithm may be used to create secure digital relationships where the pairing context (in person meeting with physical possession of devices) is known to both parties. In this way, secure pairing and communication may occur without a trusted third party entity to establish the secure digital relationship context.

Embodiments further leverage use of, e.g., motion sensors, to generate entropy, without the need for creation or access to a gesture database containing a list of gesture motions that are displayed for a user to repeat while pairing. Stated another way, instead of this database-centered approach, here device and user pairing may be performed using the same training data. Also, embodiments may enable devices to perform an exchange of an authentication confidence value that may be used to authenticate users subsequently, so that the user need not share a biometric reference template that may have higher confidence, but may also have stronger privacy constraints.

Key exchange may occur over a trustable session between trusted execution environments using a bilateral attestation protocol, in various embodiments. Furthermore, unlike existing bump-to-pair methods that upload motion information to a cloud service, motion information is shared only with the devices participating in the pairing and if a TEE is used, only within the attested TEE environments. As such, privacy sensitive location data are not shared outside of the devices being paired and if a TEE is used, only within the attested TEE environments.

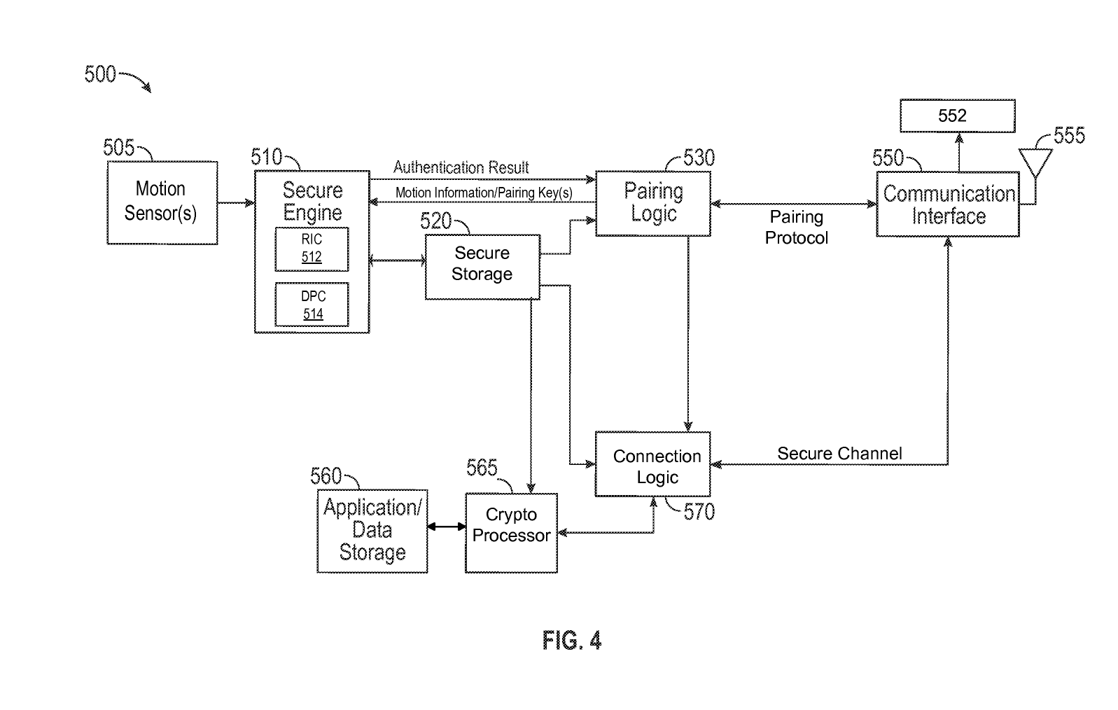

Referring now to FIG. 4, shown is a block diagram of a portion of a system in accordance with an embodiment of the present invention. As shown in FIG. 4, system portion 500 may execute in a TEE using combinations of the hardware shown in FIG. 4, along with corresponding firmware and/or software. In general, a system including portion 500 may operate in a TEE such that the motion-based pairing and authentication operations described herein are performed in a trusted and secure environment, where the system can attest to the security of the environment (and authenticate and attest to presence of an authenticated user) to a remote device (and equally receive the same assurances from the remote device). In general, portion 500 includes logic and storage to generate and maintain security and trust relevant values that are protected such that they are only accessible within portion 500 when executing in a TEE. In addition, various user inputs, whether by motion or other user authentication procedures, may be received via one or more trusted paths in portion 500.

As seen, one or more motion sensors 505 are provided to receive motion sampling information. Types of motions sensors vary in different examples and can include multi-axis accelerators, positioning sensors, orientation sensors, among others. In turn, motion sampling information from such sources are provided to a security engine 510, which in different implementations may be a standalone security processor (such as a hardware trusted platform module (TPM)) or security logic (such as a separate low complexity core) included within a general-purpose processor such as a multicore processor or other SoC.

As further seen, secure engine 510 further receives motion information from a remote system, namely motion sample information from that system. Based on the multiple motion samples, it can be determined whether the training motion samples for a given user match to at least a threshold level. In an embodiment, a device pairing classifier 514 of secure engine 510 may execute to generate a pairing key based on these local and remote motion samples. In addition, using a reference template for the user of the local device (which may be stored in a secure storage 520), a relationship identity classifier 512 may also execute to generate a confidence value, which may be of a lower quality/lower security level than a local motion reference template. In addition to storing these calculated values in secure storage 520 associated with the local user, the information may further be passed to a pairing logic 530.

In an embodiment, pairing logic 530 may generate a relationship pairing key including private and public keys (which also may be stored in secure storage 520). The corresponding public key of the relationship pairing key and the confidence value may be sent via a communication interface 550, which in an embodiment may provide for both wired and wireless communication (e.g. via a physical connector 552 and an antenna 555, respectively), to the other device.

At this point, assume that the devices are paired and the users desire to open a secure channel at a later time. To this end, authentication procedures may be performed to authenticate the local users to their devices. Furthermore, a motion authentication may be performed and the motion sample from the remote user may be communicated to enable secure engine 510 to determine whether the device and user are authenticated (based on comparison with the previously received remote motion sample obtained during training) Assuming that the devices are paired, pairing logic 530 interfaces with a connection logic 570 which, based on a given connection protocol (e.g., a wireless connection protocol) creates a secure connection between the devices, such as described above to derive a set of keys to be used for encryption of communication between the devices.

In an embodiment, secure engine 510 may generate an authentication result, e.g., to indicate whether a given user is authenticated according to a given authentication process, as dictated by an authentication policy, which also may be stored in secure storage 520. In an embodiment, the authentication policy may provide for a multi-factor authentication, such as by way of a given combination of biometric input, password, motion, or other user-based input.

With further reference to FIG. 4, a cryptoprocessor 565 may be present to perform data encryption and decryption using such derived keys. More specifically, when data is to be communicated between portion 500 and another device, cryptoprocessor 565 may encrypt such data (e.g., as stored in an application/data storage 560) prior to communication via communication interface 550 and/or decrypt received data. Understand while shown at this high level and with a limited number of components in the embodiment of FIG. 4, the scope of the present invention is not limited in this regard.

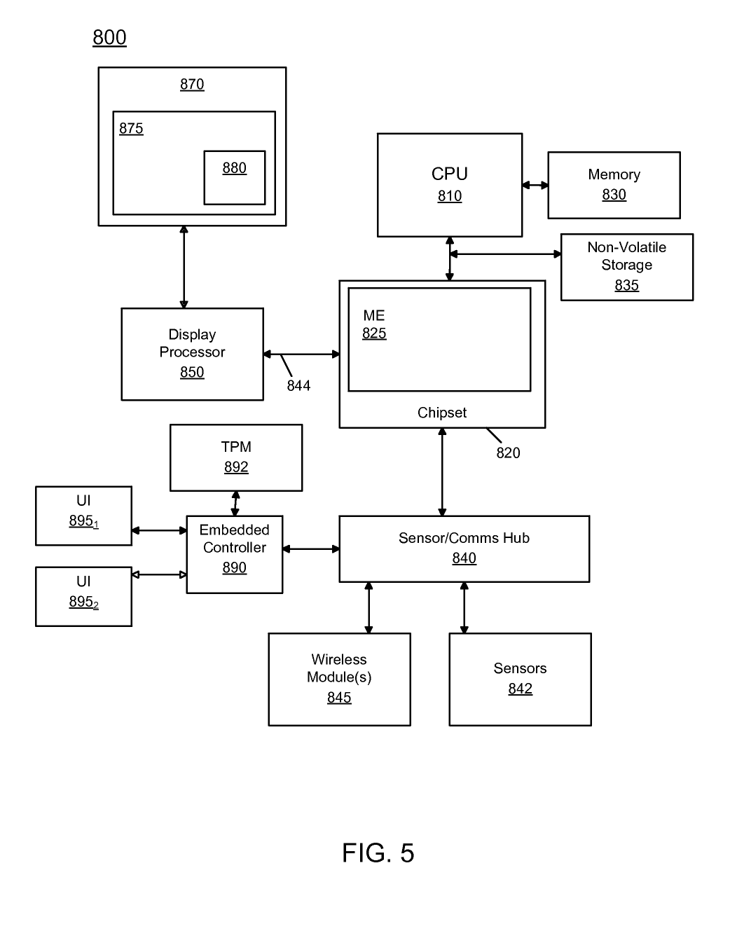

Referring now to FIG. 5, shown is a block diagram of a system arrangement in accordance with an embodiment of the present invention. As seen in FIG. 5, system 800 may be a user platform such as a mobile device, tablet, phablet, personal computer (or other form factor) and includes a CPU 810. In various embodiments, this CPU may be a SoC or other multicore processor and can include secure execution technologies to set up a trusted execution environment to be used as described herein. In different embodiments, the TEE may be implemented using Intel® SGX technology, Intel® TXT technology, or an ARM TrustZone. To this end, implementations may include various hardware, both general-purpose and specialized security hardware, to create a TEE and perform secure pairing and communication operations in such environments.

As seen in the embodiment of FIG. 5, CPU 810 may be coupled to a chipset 820. Although shown as separate components in the embodiment of FIG. 5, understand that in some implementations chipset 820 may be implemented within the same package as CPU 810, particularly when the CPU is implemented as an SoC. Chipset 820 may include a manageability engine 825 which in an embodiment may be used to perform at least portions of the motion-based pairing and connection protocols described herein. As further seen, various portions of a memory system couple to CPU 810, including a system memory 830 (e.g., formed of dynamic random access memory (DRAM)) and a non-volatile storage 835, at least portions of which may be a secure storage to store a relationship database including entries for device IDs, relationship pairing keys, reference motion templates, local and remote motion samples, device attestation information, and/or policy information as described herein.

In the embodiment of FIG. 5, additional components may be present including a sensor/communications hub 840 which may be a standalone hub or configured within chipset 820. As seen, one or more sensors 842 may be in communication with hub 840. For purposes of user authentication and device/context attestation, such sensors can include biometric input sensors, one or more motion sensor devices, and a global positioning system (GPS) module or other dedicated location sensor. In an embodiment, other sensors such as inertial and environmental sensors also may be present. As several examples, an accelerometer and a force detector may be provided and information obtained from these sensors can be used for the motion-based authentications described herein. Also, in various embodiments one or more wireless communication modules 845 may be present to enable communication with local or wide area wireless networks such as a given cellular system in accordance with a 3G or 4G/LTE communication protocol.

As further seen in FIG. 5, platform 800 may further include a display processor 850 that can be coupled to chipset 820 via channel 844, which may be a trusted channel, in some embodiments. As seen, display processor 850 may couple to a display 870 that can be a touch screen display to receive user input such as responses to authentication requests. Thus in this example, configured within the display may be a touch screen 875 and a touch screen controller 880 (which of course is hidden behind the display itself). Other user interfaces, namely user interfaces 895₁ and 895₂ which in an example can be a keyboard and a mouse, may be coupled via an embedded controller 890 to sensor/communications hub 830. Also, in the embodiment of FIG. 5, a hardware TPM 892 further couples to embedded controller 890, and may be used to perform at least portions of a pairing and/or connection protocol using secrets such as various keys.

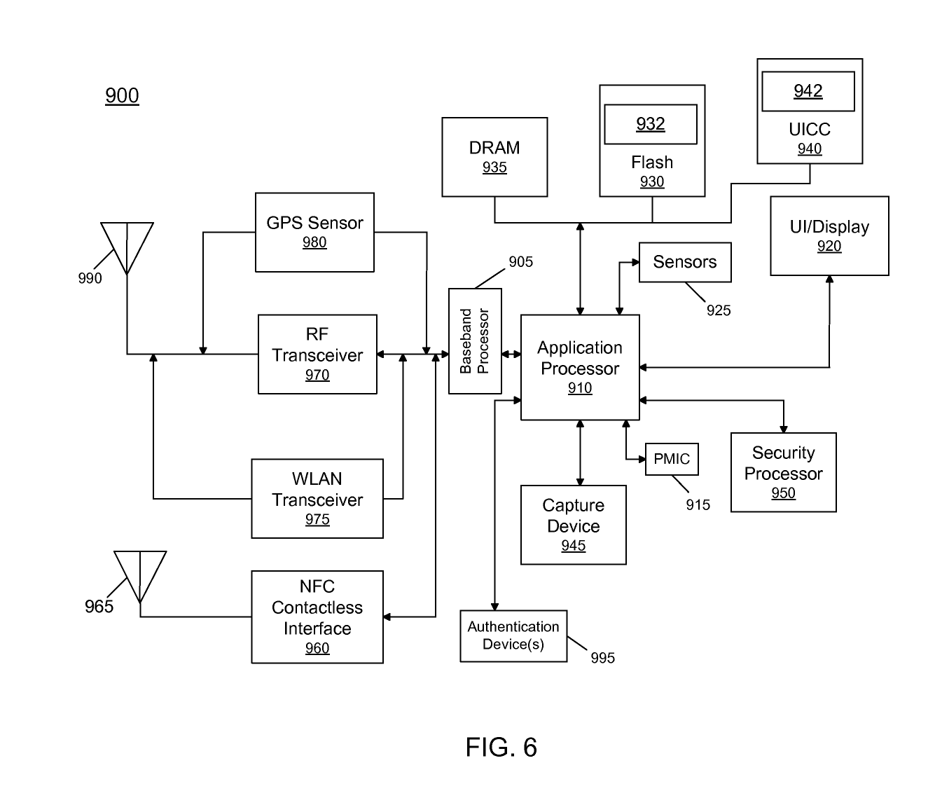

Referring now to FIG. 6, shown is a block diagram of another example system with which embodiments can be used. As seen, system 900 may be a smartphone or other wireless communicator. A baseband processor 905 is configured to perform various signal processing with regard to communication signals to be transmitted from or received by the system. In turn, baseband processor 905 is coupled to an application processor 910, which may be a main CPU of the system to execute an OS and other system software, in addition to user applications such as many well-known social media and multimedia apps. Application processor 910 may further be configured to perform a variety of other computing operations for the device.

In turn, application processor 910 can couple to a user interface/display 920, e.g., a touch screen display. In addition, application processor 910 may couple to a memory system including a non-volatile memory, namely a flash memory 930 and a system memory, namely a DRAM 935. In some embodiments, flash memory 930 may include a secure portion 932 in which secrets, such as device IDs, relationship pairing keys, motion templates, motions samples, and security policies (including pairing and connection policies for the motion-based pairing and authentications as described herein) may be stored. As further seen, application processor 910 also couples to a capture device 945 such as one or more image capture devices that can record video and/or still images.

Still referring to FIG. 6, a universal integrated circuit card (UICC) 940 comprises a subscriber identity module, which in some embodiments includes a secure storage 942 to store secure user information. System 900 may further include a security processor 950 that may couple to application processor 910. In various embodiments, at least portions of the secure pairing and connection techniques may be performed using security processor 950, which may be used in part to set up a TEE. A plurality of sensors 925, including one or more multi-axis accelerometers may couple to application processor 910 to enable input of a variety of sensed information such as motion and other environmental information. In addition, one or more authentication devices 995 may be used to receive, e.g., user biometric input for use in authentication operations.

As further illustrated, a near field communication (NFC) contactless interface 960 is provided that communicates in a NFC near field via an NFC antenna 965. While separate antennae are shown in FIG. 6, understand that in some implementations one antenna or a different set of antennae may be provided to enable various wireless functionality.

A power management integrated circuit (PMIC) 915 couples to application processor 910 to perform platform level power management. To this end, PMIC 915 may issue power management requests to application processor 910 to enter certain low power states as desired. Furthermore, based on platform constraints, PMIC 915 may also control the power level of other components of system 900.

To enable communications to be transmitted and received, various circuitry may be coupled between baseband processor 905 and an antenna 990. Specifically, a radio frequency (RF) transceiver 970 and a wireless local area network (WLAN) transceiver 975 may be present. In general, RF transceiver 970 may be used to receive and transmit wireless data and calls according to a given wireless communication protocol such as 3G or 4G wireless communication protocol such as in accordance with a code division multiple access (CDMA), global system for mobile communication (GSM), long term evolution (LTE) or other protocol. In addition a GPS sensor 980 may be present, with location information being provided to security processor 950 for use as described herein when context information is to be used in a pairing process. Other wireless communications such as receipt or transmission of radio signals, e.g., AM/FM and other signals may also be provided. In addition, via WLAN transceiver 975, local wireless communications, such as according to a Bluetooth™ or IEEE 802.11 standard can also be realized.

The following Examples pertain to further embodiments.

In Example 1, an apparatus comprises: a security logic to receive first motion sample information from at least one motion sensor of a first portable device and second motion sample information from at least one motion sensor of a second portable device, the first and second motion sample information obtained responsive to training movement of the first and second portable devices by a first user, the security logic to generate a device pairing value based on the first motion sample information and the second motion sample information, generate a first confidence value based on the first motion sample information and first reference motion sample information stored in the first portable device corresponding to reference movement of the first portable device by the first user, generate a relationship key pair for a relationship between the first user and a second user of the second portable device, and communicate the first confidence value and a public key of the relationship key pair to the second portable device; and a storage having an entry for the relationship to store the relationship key pair.

In Example 2, the security logic of Example 1 comprises a first classifier to generate the device pairing value and a second classifier to generate the first confidence value.

In Example 3, the apparatus of one of the above Examples includes a connection logic to connect the first portable device to the second portable device via a secure channel and to receive third motion sample information from the second portable device, the third motion sample information obtained responsive to movement of the second portable device by the second user, the connection logic to determine whether the third motion sample information matches fourth motion sample information received from the second portable device and obtained responsive to training movement of the second portable device by the second user to at least a threshold level, and if so to authenticate the second user and the second portable device to the first portable device.

In Example 4, the apparatus of Example 3 further comprises a sharing logic, responsive to the second user and the second portable device authentication, to generate a set of keys derived from the relationship key pair.

In Example 5, the security logic of Example 3 or 4 is optionally to execute in a trusted execution environment of the apparatus to perform the second user and the second portable device authentication without interaction with a trusted third party, the apparatus comprising the first portable device.

In Example 6, the at least one motion sensor of one of the above Examples optionally comprises one or more of a six-axis accelerometer and a nine-axis accelerometer.

In Example 7, a first computing device comprises: at least one first motion sensor to sense motion of the first computing device; a processor to execute instructions and including a security logic to perform a training protocol to receive motion-based training information for a first user and a second user from the at least one first motion sensor and from a second computing device and to generate a first relationship pairing key for a relationship between the first user and the second user based on the motion-based training information without interaction with a trusted third party, where the security logic is to receive the motion-based training information responsive to a training motion operation performed on the first and second computing devices by each of the first and second users, to enable the first computing device to pair with the second computing device; and a first storage to store a first relationship entry including a public key of a second relationship pairing key for the relationship between the first user and the second user received from the second computing device, a private key of the first relationship pairing key, a first motion sample of the motion-based training information for the first user and a second motion sample of the motion-based training information for the second user.

In Example 8, the security logic of Example 7 is to execute in a trusted execution environment of the first computing device.

In Example 9, the security logic of Example 7 or 8 comprises a relationship identify classifier to generate a first confidence value based on a motion reference template for the first user and the first motion sample, and to provide the first confidence value to the second computing device.

In Example 10, the relationship identity classifier of Example 9 is optionally to receive a later motion sample for the second user from the second computing device and to determine whether the later motion sample matches the second motion sample of the motion-based training information for the second user to at least a second confidence value, the second confidence value received from the second computing device.

In Example 11, the security logic of Example 10, responsive to the later motion sample matching the second motion sample to at least the second confidence value, is to enable the first computing device to share information with the second computing device via a secure channel.

In Example 12, the security logic of one of Examples 7-11 comprises a device pairing classifier to generate the first relationship pairing key based on the first motion sample and a third motion sample of the motion-based training information for the first user received from the second computing device.

In Example 13, the device pairing classifier of Example 12 is optionally to perform a logical operation on the first motion sample and the third motion sample to determine whether a result of the logical operation exceeds a threshold, and if so to generate a device pairing value, the device pairing value to be used to communicate a public portion of the first relationship pairing key to the second computing device.

In Example 14, the security logic, responsive to the result of the logical operation of Example 13 not exceeding the threshold, is to prevent the first computing device from pairing with the second computing device.

In Example 15, the security logic of one of Examples 7-14 is further to generate the first relationship pairing key based on context information associated with an in-person interaction between the first user and the second user.

In Example 16, the security logic of Example 15 is optionally to encrypt the shared information using the private key of the first relationship pairing key.

In Example 17, at least one computer readable storage medium comprises instructions that when executed enable a first system to: receive motion sample information from a local motion sensor associated with the first system and from a remote motion sensor associated with a second system, the motion sample information responsive to training movement of the first and second systems by a first user; generate a first pairing key for the first user based on the motion sample information; and generate and store a first relationship key pair including a first public key and a first private key based at least in part on the first pairing key and store the first relationship key pair in a first entry of a storage associated with a relationship between the first user and a second user of the second system, the first relationship key pair to enable the first and second systems to pair when located remotely to each other.

In Example 18, the at least one computer readable storage medium of Example 17 optionally further comprises instructions that when executed enable the first system to: generate a reference motion template for the first user based at least in part on collected motion sample information from the local motion sensor and store the reference motion template in a first storage of the first system.

In Example 19, the at least one computer readable storage medium of Example 18 optionally further comprises instructions that when executed enable the first system to generate a first confidence value based on the reference motion template, the first confidence value of a lower security level than the reference motion template, and send the first confidence value to the second system to enable the second system to authenticate future motion sample information from the first system, the future motion sample information responsive to pairing movement of the first system by the first user.

In Example 20, the at least one computer readable storage medium of Example 18 optionally further comprises instructions that when executed enable the first system to authenticate the second user and the second system without interaction with a trusted third party.

In Example 21, a method comprises: receiving motion sample information from a local motion sensor associated with a first system and from a remote motion sensor associated with a second system, the motion sample information responsive to training movement of the first and second systems by a first user; generating a first pairing key for the first user based on the motion sample information; and generating and storing a first relationship key pair including a first public key and a first private key and storing the first relationship key pair in a first entry of a storage associated with a relationship between the first user and a second user of the second system, the first relationship key pair to enable the first and second systems to pair when located remotely to each other.

In Example 22, the method of Example 21 further comprises generating a reference motion template for the first user based at least in part on collected motion sample information from the local motion sensor and storing the reference motion template in a first storage of the first system.

In Example 23, the method of Example 22 optionally further comprises generating a first confidence value based on the reference motion template, the first confidence value of a lower security level than the reference motion template, and sending the first confidence value to the second system to enable the second system to authenticate future motion sample information from the first system, the future motion sample information responsive to pairing movement of the first system by the first user.

In Example 24, the method of Example 22 optionally further comprises authenticating the second user and the second system without interaction with a trusted third party.

In Example 25, a machine-readable storage medium includes machine-readable instructions, when executed, to implement a method of any one of Examples 21 to 24.

In Example 26, an apparatus comprises means for performing the method of any one of Examples 21 to 24.

In Example 27, an apparatus comprises: means for receiving motion sample information from a local motion sensor associated with a first system and from a remote motion sensor associated with a second system, the motion sample information responsive to training movement of the first and second systems by a first user; means for generating a first pairing key for the first user based on the motion sample information; means for generating and storing a first relationship key pair including a first public key and a first private key based at least in part on the first pairing key; and means for storing the first relationship key pair in a first entry of a storage associated with a relationship between the first user and a second user of the second system, the first relationship key pair to enable the first and second systems to pair when located remotely to each other.

In Example 28, the apparatus of Example 27 further comprises: means for generating a reference motion template for the first user based at least in part on collected motion sample information from the local motion sensor; and means for storing the reference motion template in a first storage of the first system.

In Example 29, the apparatus of Example 28 optionally further comprises means for generating a first confidence value based on the reference motion template, the first confidence value of a lower security level than the reference motion template, and sending the first confidence value to the second system to enable the second system to authenticate future motion sample information from the first system, the future motion sample information responsive to pairing movement of the first system by the first user.

In Example 30, the apparatus of Example 28 optionally further comprises means for authenticating the second user and the second system without interaction with a trusted third party.

Understand also that various combinations of the above Examples are possible.

Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
a security logic to receive first motion sample information from at least one motion sensor of a first portable device and second motion sample information from at least one motion sensor of a second portable device, the first and second motion sample information obtained responsive to training movement of the first and second portable devices by a first user, the security logic to generate a device pairing value based on the first motion sample information and the second motion sample information, generate a first confidence value based on the first motion sample information and first reference motion sample information stored in the first portable device corresponding to reference movement of the first portable device by the first user, generate a relationship key pair for a relationship between the first user and a second user of the second portable device, and communicate the first confidence value and a public key of the relationship key pair to the second portable device using the device pairing value; and
a storage having an entry for the relationship to store the relationship key pair.

2. The apparatus of claim 1, wherein the security logic comprises a first classifier to generate the device pairing value and a second classifier to generate the first confidence value.

3. The apparatus of claim 1, further comprising a connection logic to connect the first portable device to the second portable device via a secure channel and to receive third motion sample information from the second portable device, the third motion sample information obtained responsive to movement of the second portable device by the second user, the connection logic to determine whether the third motion sample information matches fourth motion sample information received from the second portable device and obtained responsive to training movement of the second portable device by the second user to at least a threshold level, and if so to authenticate the second user and the second portable device to the first portable device.

4. The apparatus of claim 3, further comprising a sharing logic, responsive to the second user and the second portable device authentication, to generate a set of keys derived from the relationship key pair.

5. The apparatus of claim 3, wherein the security logic is to execute in a trusted execution environment of the apparatus to perform the second user and the second portable device authentication without interaction with a trusted third party, the apparatus comprising the first portable device.

6. The apparatus of claim 1, wherein the at least one motion sensor of the first portable device comprises one or more of a six-axis accelerometer and a nine-axis accelerometer.

7. A first computing device comprising:
at least one first motion sensor to sense motion of the first computing device;
a processor to execute instructions and including a security logic to perform a training protocol to receive motion-based training information for a first user and a second user from the at least one first motion sensor and from a second computing device and to generate a first relationship pairing key for a relationship between the first user and the second user based on the motion-based training information without interaction with a trusted third party, wherein the security logic is to receive the motion-based training information responsive to a training motion operation performed on the first and second computing devices by each of the first and second users, to enable the first computing device to pair with the second computing device; and
a first storage to store a first relationship entry including a public key of a second relationship pairing key for the relationship between the first user and the second user received from the second computing device, a private key of the first relationship pairing key, a first motion sample of the motion-based training information for the first user and a second motion sample of the motion-based training information for the second user.

8. The first computing device of claim 7, wherein the security logic is to execute in a trusted execution environment of the first computing device.

9. The first computing device of claim 7, wherein the security logic comprises a relationship identify classifier to generate a first confidence value based on a motion reference template for the first user and the first motion sample, and to provide the first confidence value to the second computing device.

10. The first computing device of claim 9, wherein the relationship identity classifier is to receive a later motion sample for the second user from the second computing device and to determine whether the later motion sample matches the second motion sample of the motion-based training information for the second user to at least a second confidence value, the second confidence value received from the second computing device.

11. The first computing device of claim 10, wherein the security logic, responsive to the later motion sample matching the second motion sample to at least the second confidence value, to enable the first computing device to share information with the second computing device via a secure channel.

12. The first computing device of claim 9, wherein the security logic comprises a device pairing classifier to generate the first relationship pairing key based on the first motion sample and a third motion sample of the motion-based training information for the first user received from the second computing device.

13. The first computing device of claim 12, wherein the device pairing classifier is to perform a logical operation on the first motion sample and the third motion sample to determine whether a result of the logical operation exceeds a threshold, and if so to generate a device pairing value, the device pairing value used to generate the first relationship pairing key.

14. The first computing device of claim 13, wherein the security logic, responsive to the result of the logical operation not exceeding the threshold, is to prevent the first computing device from pairing with the second computing device.

15. The first computing device of claim 9, wherein the security logic is further to generate the first relationship pairing key based on context information associated with an in-person interaction between the first user and the second user.

16. The first computing device of claim 15, wherein the security logic is to encrypt the shared information using the private key of the first relationship pairing key.

17. At least one computer readable storage medium comprising instructions that when executed enable a first system to:
receive motion sample information from a local motion sensor associated with the first system and from a remote motion sensor associated with a second system, the motion sample information responsive to training movement of the first and second systems by a first user;
generate a first pairing key for the first user based on the motion sample information; and
generate and store a first relationship key pair including a first public key and a first private key and store the first relationship key pair in a first entry of a storage associated with a relationship between the first user and a second user of the second system, the first relationship key pair to enable the first and second systems to pair when located remotely to each other.

18. The at least one computer readable storage medium of claim 17, further comprising instructions that when executed enable the first system to:
generate a reference motion template for the first user based at least in part on collected motion sample information from the local motion sensor and store the reference motion template in a first storage of the first system.

19. The at least one computer readable storage medium of claim 18, further comprising instructions that when executed enable the first system to generate a first confidence value based on the reference motion template, the first confidence value of a lower security level than the reference motion template, and send the first confidence value to the second system to enable the second system to authenticate future motion sample information from the first system, the future motion sample information responsive to pairing movement of the first system by the first user.

20. The at least one computer readable storage medium of claim 18, further comprising instructions that when executed enable the first system to authenticate the second user and the second system without interaction with a trusted third party.
